(19) United States
(12) Patent Application Publication
(10) Pub. No.: US 2013/0173238 A1
(43) Pub. Date: Jul. 4, 2013

(54) METHOD FOR THE MODELING OF CRYOGENIC SPILLS AND POOL FIRES ON THE MARITIME TRANSPORTATION OF LIQUEFIED NATURAL GAS (LNG)

(71) Applicant: Faculdades Catolicas, Associacao sem fins lucrativos, Mantenedora da Pontificia Universidade Catolica d, Rio de Janeiro (BR)

(72) Inventor: Alan da Silva Esteves, Rio de Janeiro (BR)

(73) Assignee: Faculdades Catolicas, Associacao sem fins lucrativos, Mantenedora da Pontificia Universidade, Rio de Janeiro (BR)

(21) Appl. No.: 13/733,970

(22) Filed: Jan. 4, 2013

(30) Foreign Application Priority Data
Jan. 4, 2012 (BR) 1020120001659

(51) Int. Cl. G06F 17/50

(52) U.S. Cl. CPC G06F 17/5009
USPC 703/2

(57) ABSTRACT

Mathematical modeling of the flow and spreading mechanics of a cryogenic fluid poured into the sea forming a pool, and the subsequent thermal plume coming from fires of turbulent diffusion, with conservative integral formulation considering the balance between the quantity poured from the ship and that which vaporizes in the pool. The contributions of the mechanisms of heat transfer at the interface between the substrate and the cryogenic film and the radiative feedback coming from the combustion in the lowest region of the thermal plume and the pool are taken into account. The modeling provides a scheme for the development of dimensionless scale parameters, allows correlation and extrapolation of the length or height of the visible flame with the slope of said flame, the emissive power of its surface, and mass flow rate of vaporization of the liquid fuel in the pool.

### STATEMENT OF RELATED APPLICATIONS

This patent application is based on and claims the benefit of Brazilian Patent Application No. 10 2012 000165 9 having a filing date of 4 Jan. 2012.

### BACKGROUND OF THE INVENTION

1. Field of the Invention

The present invention is in the field of methods for the modeling of the mechanical flow and spreading of a cryogenic fluid (Liquefied Natural Gas—LNG) poured into the sea and forming a pool, and the subsequent thermal plume coming from fires of turbulent diffusion. The spill and the spreading of the pool are modeled with integral conservative formulation, considering the balance between the quantity poured from the ship and that which vaporizes in the pool. It takes into account, fundamentally, the contributions of the heat transfer mechanisms at the interface between the substrate and the cryogenic film, and the radiative feedback coming from the combustion in the lowest region of the thermal plume and the pool itself. Modeling includes combustion zones and flickering of the fire's thermal plume. It provides a consistent and robust scheme for the development of dimensionless scale parameters, allowing to correlate and extrapolate the length (or height) of the visible flame with the slope of said flame, the emissive power of its surface and mass flow rate of vaporization of the liquid fuel in the pool. The modeling, in addition to being conservative integral, considers the emissive power variation with the visible plume height, the dependency to the diameter of the fire and the variation of the plume dimensions and fuel properties with the ‘luminous’ zone height from the fire base and the rate of smoke production. The model also includes the thermal radiation emitted by gray gases transporting soot particles in the combustion zone, considering emission and absorption in the optically thin and thick regions of the fire plume.

2. Prior Art

LNG is natural gas liquefied by reducing its temperature to −162° C. at normal atmospheric pressure. Liquefied Natural Gas (LNG) has been carried since 1959 in LNG tankers, essential links in the handling of LNG between production and consumption locations. Natural gas is a subcategory of oil that occurs in nature. It represents a complex mixture of hydrocarbons with a small amount of inorganic compounds and is one of the largest fossil energy sources being used by almost all sectors of the global economy, which allows it to be regarded as a commodity.

The LNG industry is currently facing challenges to obtain the approval of new terminals to receive and export. One aspect that is attracting increasing interest from civil society in the public hearings for the licensing of these terminals is related to the danger of the activity in view of the fear of the consequences of catastrophic accidents with LNG associated with the maritime transport and acts of terrorism.

The main risks of interest for LNG are: fire, confined or partially confined explosion, rapid phase transition and effects related to their cryogenic storage temperature, such as, for example, cryogenic burns, choking. Compared with the Liquefied Petroleum Gas (LPG) and liquefied ethylene, LNG is less dangerous due to: (i) its low density, (ii) its trend of not forming a flammable vapor cloud in environmental conditions, (iii) its minimum ignition energy being relatively high, and (iv) having lower fundamental combustion speed. LNG is not toxic and evaporates quickly; consequently, considering a long spill time, the environmental impacts of an accidental spill are insignificant if there is no ignition of the vapors formed.

Basically, there are three types of fire possible to occur in maritime activities with LNG: pool fire, jet fire and flash fire. Modeling of large LNG spills, which until now were not required, came to be a mandatory requirement of regulations performed by independent risk analysis studies.

Density and probability functions are virtually impossible to be used to model a thermal plume 300 m in diameter with a height of about 500 m. It would have to generate random numbers for trillions of smoke particles to be mapped. The present invention, on the other hand, provides a method that comprises the mathematical modeling of mechanical flow and spreading of a cryogenic fluid (Liquefied Natural Gas—LNG) poured into the sea forming a pool and the subsequent thermal plume coming from fires of turbulent diffusion.

Within the patent ambit, some documents considered only partially relevant were located and described below.

U.S. Pat. No. 7,240,499 describes a method to prevent explosions during the transportation of natural gas in floating craft which implies in acquiring a gas of highly pressurized content. The gas is dehydrated to a pressurized dry gas which is then cooled forming two phases. The two phases, liquefied and condensed natural gas, are placed in storage forming a mixture. The present invention differs from the above document because, among other technical reasons, it comprises the mathematical modeling of cryogenic spills and pool fires in the maritime transport of liquefied natural gas, a fact not mentioned in this document.

US Patent Publication No. 2008/0264076 describes a system for re-liquefaction of natural gas when it reaches the boiling point comprising the use of a scroll compressor and an effective compression band between 10% and 100% of the rate of capacity. The system comprises heat exchangers and refrigerants, in addition to compressor, phase separators and expansion valve. The present invention differs from the above document because, among other technical reasons, it comprises the mathematical modeling of cryogenic spills and pool fires in the maritime transport of liquefied natural gas, a fact not mentioned in this document.

From what is understood from the literature, no documents preceding or suggesting the teachings of this invention have been found, so that the solution proposed herein, in the eyes of the inventors, has novelty and nonobviousness in view of the prior art.

### BRIEF SUMMARY OF THE INVENTION

The present invention provides a method for modeling the mechanics of cryogenic pool spills on maritime transportation of Liquefied Natural Gas (LNG). The method of the invention comprises a step of mathematical modeling for describing a thermal plume of a fire of turbulent diffusion formed by the flow mechanics of a cryogenic fluid, LNG, which when poured through a tear on the hull of an LNG tanker forms a pool, which supposedly is immediately ignited.

The method of the invention provides numerous advantages including: conservative integral formulation, discarding the distinction between instant and continuous spills; integration of partial differential equations of the flow history with analytical and numeric solutions; use of dimensionless variables in relation to time, volume, area and scales of length, simplifying the addressing of the problem and the writing of equations; it expresses the maximum area of the pool and the vaporizing time as a function of a single dimensionless flow parameter; it uses a single parameter of form and spreading, beaming the asymmetrical spreading in the current lines of the pool; it uses a semicircular shaped pool, which best describes the phenomenology of the problem.

These and other objects of the invention will be immediately appreciated by a person skilled in the art and by companies interested in the field, and will be described in sufficient detail for its reproduction in the description below.

### DETAILED DESCRIPTION OF PREFERRED EMBODIMENTS

The method for modeling the mechanics of cryogenic pool spills on maritime transportation of Liquefied Natural Gas (LNG) of the invention provides incremental contributions to the assessment of spilling/spreading at the sea followed by pool fire of turbulent diffusion of LNG. In the present invention, the spill and the spreading of the pool are modeled with conservative integral formulation considering the balance between the amount poured from the ship and that which vaporizes in the pool. The method of the invention considers the contributions of the mechanisms of heat transfer at the interface between the substrate and the cryogenic film and the radiative feedback coming from the combustion in the lowest region of the thermal plume and pool itself.

The method of the invention includes the combustion and flickering zones of the thermal plume from the fire. It provides a consistent and robust scheme for the development of dimensionless scale parameters, allowing to correlate and extrapolate the length (or height) of the visible flame with the slope of said flame, the emissive power of its surface and mass flow rate of vaporization of the liquid fuel in the pool.

The method of the invention includes conservative integral and also semi-empirical modeling, and considers the emissive power variation with the height of the visible plume, the dependency on the diameter of the fire and the variation of the plume dimensions and fuel properties with the ‘luminous’ zone height from the fire base and the rate of smoke production.

The method of the invention also includes the evaluation of thermal radiation emitted by gray gases transporting soot particles in the combustion zone considering emission and absorption in the optically thin and thick regions of the plume from the fire.

Spill Phenomenology

In order to understand the physics involved, consider a spill from a tear on an LNG tanker's hull. The determination of the quantity poured is the first step to predict potential dangers. The hole on the hull of the ship, on one or more of its tanks, can occur above or below the waterline. Assessment of the leakage or spillage rate of LNG in the water depends on, for example, the form of the tank, its size, the percentage of filling, the location of the hole on the ship's hull.

Another rate of interest is the one about how the cryogenic fluid vaporizes in the pool formed after the spill, and that is the rate that appears in the literature with different names according to each experimentalist. It could be mentioned, for example: ‘burning rate’, ‘combustion rate’, ‘fuel volatization rate’, ‘shrinking rate’, ‘vaporization rate’.

Focusing on the pool, we opted to establish a standardization of the nomenclature on how to express this rate. What is measured, usually, is the average speed between the values acquired in the experiments, in m/s, with which the pool regresses in size due to the vaporization of the cryogenic liquid. In the present invention it has been verified that it is estimated by dividing the total volume of LNG spilled by the measured area of the pool and by the length of time experienced during the intense burning in steady-state. This shrinkage generally starts to take place from when it does not spread anymore. However, there are several names for the same phenomenon: evaporation, volatilization, vaporization, to mention but a few.

The composition of LNG also affects the size of pool, since the presence of ethane and propane tends to increase the vaporization rate and collapse the film's steam formed on the interface, thus decreasing the size of the pool. RPTs (Rapid Phase Transitions) may also occur in the pool causing an increase in the vaporization rate. If the LNG released ignites immediately, a pool fire occurs. And if the ignition is not immediate, the LNG will rapidly vaporize, producing a cloud visible just above the water level that will spread with the wind. The LNG steam is colorless, but, due to its very low temperature, the water vapor mixed in the atmosphere condenses and produces a visible cloud. Although there are various components in LNG, methane will evaporate first, because it is the most volatile component, and, thus, the cloud will be composed primarily of methane.

In the present invention it is shown that, by the end of the methane vaporization, the heavier components which form part of the cloud's composition start to evaporate, once methane is predominant due to its greater relative volatility and fugacity, in addition to not forming neither maximum nor minimum azeotrope mixtures with the ‘heavier’ components, especially ethane and propane. The cloud formed will blend with the air, especially in the periphery and along its edges, and when the methane concentrations are between the lower flammable limit (LFL) and upper flammable limit (UFL) the cloud will be susceptible to ignition.

However, before we move on to the physics of the combustion phenomena of pools formed due to LNG spills in the water or on land, it is appropriate to comment on the formation of pools for a better understanding of the phenomena associated with the combustion of the fires in itself, which is one of the objectives of this work. For pools with non-confined LNG spills in the water, said pools experience spreading and begin to boil with a high vaporization rate. This rate is constantly maintained due to a continuous contact by a film formed between LNG and the water at a much higher temperature.

The spreading of an LNG pool in water is a matter that is still being discussed, generates controversy and until today there is no clear and single consensus. Therefore, the present invention is not intended to exhaust the subject that is being researched until today.

When the vaporization of the pool occurs by the film boiling regime, a thin layer or film of LNG steam between the surface of the water and the LNG pool is formed. In the inertial-gravitational regime, i.e. at the beginning of the spill, the inertial forces governing the flow are balanced by viscous forces, assuming, however, simplifications. In this regime, the friction forces are present but are small when compared with inertia forces and, therefore, can be relaxed. The opposite occurs when the flow is more developed, when the regime is viscous-gravitational, the inertial forces are still present, but, in general, are small compared with the viscous forces. The point of transition between these two regimes is typically assumed when the inertial and viscous forces are equal. Since the LNG vaporizes quickly when poured in the water, the majority of spills evaporate completely before viscous friction forces become important. However, in case of fast (high flow rate) and large spills, they can endure long enough so that these forces should be considered.

The LNG spill is immediately followed by ignition with subsequent fire in the pool poured out, it is difficult for its flow to transfer from inertial-gravitational to viscous-gravitational-viscous flow. However, if the ignition is delayed, according to some authors, the pool may flow transferring through the viscous-gravitational regime until it reaches the viscous-surface tension regime when the film reaches a minimum thickness. For large spills, LNG leaks in the water may transfer to the viscous-gravitational regime, and the reason for the existing models to disregard this effect is related with the much smaller volumes used in tests and experiments when compared with volumes required so that the minimum thickness is reached.

If the spill is confined to calm waters (quiescent waters), the lack of spreading can cause the formation of a layer of ice below the LNG lamina. As the thickness of this layer increases, the heat transfer rate decreases, thus reducing the vaporization rate. The boiling speed should be similar for spills confined to land, since there is a reduction of vaporizing speed with time. Small formations of ice were also observed in spills not confined to water, but during the spreading, the turbulent interface created between the LNG and water as well as the high rate of heat transfer provided by water before the fire prevent any significant formation of ice. Once the LNG pool has spread to its maximum area and diameter, its thickness becomes minimal. After achieving this thickness, it remains constant with the constant steaming, while the pool area starts to decrease. At a given time, the surface tension is not capable of maintaining the film continuous anymore, and thus the LNG layer can break. There are records showing that this film has a minimum thickness of 1 mm to 1.7 mm independently of the amount of LNG spilled. As it is not robust enough, it does not provide thermal inertia to allow it to freeze significant quantities of water.

In practice, the maximum steaming time and the maximum radius of an LNG spill in a quiescent water sea are calculated by discarding the minimum layer thickness and the loss due to LNG vaporization that is submerged in water during the spill. In this case, it is assumed that the maximum pool radius is reached by the time the LNG has been entirely evaporated.

The evaporation time and the maximum pool radius without considering the formation of film of minimum thickness demonstrated that there is a 5% difference in relation to the cases where it is considered it in the modeling methods found in the literature.

Higher steaming speeds result in larger LFL distances, which affect the extent of the dangers of flash fire and explosions. Increasing this speed will also increase the global steaming speed (and the mass flow rate), as there are heat transfer contributions from the water in the process of boiling and the feedback of heat radiated from the fire.

The boiling of the pool occurs when LNG is poured out on the water due to the high temperature difference of approximately 180 K between both. The pool boiling and the corresponding heat transfer rates modes are a function of that difference. It is as if, hypothetically, the surface of a volume of LNG immersed within the water was brought to the surface of water in its boiling point. At this temperature, there is no steam formation or the boiling called ‘nucleated boiling regime’, where the ‘nucleation’ sites (cavities impregnated with steam or gas) on the surface of LNG allow the formation of bubbles. Although the nucleation is regarded as occurring in a solid surface, it may also occur in a homogeneous liquid. With the subsequent increase in surface temperature, the formation of bubbles increases, producing high local speeds inside the film close to the surface, increasing, therefore, the heat transfer. Thus, in this scheme, an increase in the difference of temperature increases the transfer of heat to the cryogenic liquid. There is, then, a peak of heat flow in the ‘nucleated boiling regime’. Eventually, the formation of bubbles is so fast that the liquid is prevented from coming in contact with the surface and the heat flow decreases. This is called the transition regime. With the continued increase in surface temperature, it will be covered by a continuous steam film and heat transfer will be reduced, since the heat is transported more scarcely through the steam film with low conductivity. This is known as ‘film boiling regime’, and the minimum temperature for forming a stable boiling film is called Leindenfrost temperature or point.

With subsequent increases in temperature, the heat transfer mode becomes radiative and increasing this rate. And it is due to the Leidenfrost effect that the evaporating LNG pool spreading in calm (quiescent) waters can be considered, in practice, as an essentially inviscid flow. The formed cloud mixes with air, particularly at its borders, and when methane concentrations are between the LFL and UFL, i.e., between 5% and 15% v/v respectively, the mixture will be able to sustain the flame of a fire in case it is ignited.

In the scientific literature of fires, the thermal radiation is already consecrated as the dominant mechanism of heat transfer, ruling the growth and spread of some types of fire. Two main types of types of fires are cited in the literature (Sacadura, 2005): (i) in compartments (enclosure fires), and (ii) external (outdoors). The first group comprises buildings, rooms, tunnels. Among the external are forests or wild life sites, differentiated from fires in industrial plants or urban fires (outside the buildings).

In industrial spills, the non-premixed combustion is referred to in the industry as ‘fire’, with the fuel-air mixing rate being ruled by the turbulent flow diffusion (it is found in the literature that, in laboratory scale, non-premixed combustion is referred to as diffusion flame). If the ignition occurs immediately after the spill before the mixing takes place instead of in the end when the fuel is completely mixed with the air, then the combustion will be ‘non-premixed’. Usually non-premixed combustion occurs in the first place. With the junction of these two terms, turbulence and diffusion, it is common to find in literature equivalent expressions such as ‘turbulent diffusion fire’, ‘turbulent diffusion flame’. Especially in the case of LNG spills, the fire is referred to as ‘pool fire’ or ‘spill fire’, since the liquid spilled from the tanker results in a quasi-steady-state fire. The danger of this type of combustion is essentially thermal, since it comes from a thermal radiation flow.

The process of combustion beams chemical reagents transformations, during which large quantities of heat are released in recombinations between the atoms making up the system; on most reaction systems, the chemical reaction rate is a function that grows with the temperature. These characteristics together imply that these processes self-accelerate once initiated; in addition, according to such characteristics, the chemical transformations and the heat transfer have small time and length scales when compared with the scales of the flow geometry.

Fundamental Turbulence Phenomena

In laminar flow, velocity and scalars have well defined values. On the other hand, turbulent flow is characterized by continuous fluctuations in speed causing fluctuations in scalars such as density, temperature and mixture composition. Such fluctuations are the result of vortices generated by shear within the flow.

Take, for example, two fluids within a plume of fire, in which the fuel is supposedly in the bottom (in the pool) and oxidant air is above (in the thermal plume). It is observed experimentally that: (i) the fluid from the top is transported by convection (instead of diffusion) in counter-current in the downward direction within the plume, while the fluid from the bottom is transported by convection towards the top. The convection is generated by the movement of vortices due to internal shear stresses within the flow. This process accelerates the movement of the mix in an expressive manner; (ii) the interface area between these two fluids greatly increases, and, thus, the overall rate of molecular mixing is also amplified. Additionally, the rate is accelerated by steepened gradients when the interface is stretched.

The growth of these vortices is nothing more than the result of competition between the (non-linear) generation process when a critical value of Reynolds number (inertial vs. viscous forces in fluids) is exceeded, and then the transition from a laminar to turbulent flow takes place. This dimensionless value can be interpreted also as a balance between the amount of linear movement destabilizing the flow behavior and the stabilizing effect of viscous damping. As it is known, above the value of around 2,000 for the conventional Reynolds number, the viscous forces no longer dampen the instabilities caused by the amount of linear movement, redounding in the transition above; and, consequently, it emphasizes even more the disorganization, promoting axial and radial mixing within the plume. If the flow were being transported in a conduit of fixed walls, this transfer of quantity of linear movement would be manifested by a pressure drop more steepened in turbulent than in laminar flow with the same volumetric flow rate.

Turbulence Scales in Fluids

Turbulent processes occur at several scales. The larger scale of length corresponds to the geometric dimension of the system, which is the full length scale, l₀. Large wavelength disruptions (low frequencies) are associated with large eddies or vortices. They interact with one another and undergo fission in increasingly smaller eddies with smaller wavelength (high frequency), forming an energy cascade (Kolmogorov's cascade) from the largest to the smallest vortices as seen above. And most of the kinetic energy is due to the movement of the larger eddies. The energy cascade ceases when the kinetic energy of many small eddies with length equal to or smaller than the length of the Kolmogorov scale, [symbol] , is dissipated by viscous damping in thermal energy, i.e. molecular movement.

The turbulent kinetic energy (TKE) distribution, [symbol] throughout the eddy spectrum with a given diameter is described by the ‘turbulent energy spectrum’. The energy density describes the turbulent kinetic energy dependency on the number of waves, i.e., the inverse of the diameter of eddies or the length of the turbulence scale. In the length of the Kolmogorov scale, [symbol] , the time it takes for a vortex to perform half of a revolution, is equal to the diffusion time through vortex diameter [symbol] . Below [symbol] , the diffusion (and in general the molecular transport) is faster than the turbulent transport, therefore, the turbulence does not extend below [symbol] . As the goal is to have a turbulence assessment, the Reynolds number has been defined as turbulent Re_{T}.

What is claimed is:

1. A method for the modeling of cryogenic spills and pool fires in maritime transport of liquefied natural gas comprising a conservative integral formulation considering the balance between the amount poured from the ship and that which vaporizes in the pool, the modeling comprising:
the contributions from the mechanisms of heat transfer at the interface between the substrate and the cryogenic film; and
the radiative feedback coming from the combustion in the lowest region of the thermal plume and pool itself.

2. The method according to claim 1, the modeling further comprising the combustion zones and flickering of thermal plume of the fire.

3. The method according to claim 1, wherein the method provides the correlation and extrapolation of the length or height of the visible flame with the slope of said flame, the emissive power of its surface and the mass flow rate of vaporization of the liquid fuel in the pool.

4. The method according to claim 1, wherein the method considers the variation of emissive power with the height of the visible plume, the dependency on the diameter of the fire and the variation of the plume dimensions and fuel properties with the ‘luminous’ zone height from the base of the fire and the rate of smoke production.

5. The method according to claim 1, the modeling further comprising the thermal radiation emitted by gray gases transporting soot particles in the combustion zone considering emission and absorption in the optically thin and thick regions of fire's plume.

6. The method according to claim 2, wherein the method provides the correlation and extrapolation of the length or height of the visible flame with the slope of said flame, the emissive power of its surface and the mass flow rate of vaporization of the liquid fuel in the pool.

7. The method according to claim 2, wherein the method considers the variation of emissive power with the height of the visible plume, the dependency on the diameter of the fire and the variation of the plume dimensions and fuel properties with the ‘luminous’ zone height from the base of the fire and the rate of smoke production.

8. The method according to claim 3, wherein the method considers the variation of emissive power with the height of the visible plume, the dependency on the diameter of the fire and the variation of the plume dimensions and fuel properties with the ‘luminous’ zone height from the base of the fire and the rate of smoke production.

9. The method according to claim 6, wherein the method considers the variation of emissive power with the height of the visible plume, the dependency on the diameter of the fire and the variation of the plume dimensions and fuel properties with the ‘luminous’ zone height from the base of the fire and the rate of smoke production.

10. The method according to claim 2, the modeling further comprising the thermal radiation emitted by gray gases transporting soot particles in the combustion zone considering emission and absorption in the optically thin and thick regions of fire's plume.

11. The method according to claim 3, the modeling further comprising the thermal radiation emitted by gray gases transporting soot particles in the combustion zone considering emission and absorption in the optically thin and thick regions of fire's plume.

12. The method according to claim 4, the modeling further comprising the thermal radiation emitted by gray gases transporting soot particles in the combustion zone considering emission and absorption in the optically thin and thick regions of fire's plume.

13. The method according to claim 6, the modeling further comprising the thermal radiation emitted by gray gases transporting soot particles in the combustion zone considering emission and absorption in the optically thin and thick regions of fire's plume.

14. The method according to claim 7, the modeling further comprising the thermal radiation emitted by gray gases transporting soot particles in the combustion zone considering emission and absorption in the optically thin and thick regions of fire's plume.

15. The method according to claim 8, the modeling further comprising the thermal radiation emitted by gray gases transporting soot particles in the combustion zone considering emission and absorption in the optically thin and thick regions of fire's plume.

16. The method according to claim 9, the modeling further comprising the thermal radiation emitted by gray gases transporting soot particles in the combustion zone considering emission and absorption in the optically thin and thick regions of fire's plume.
